(19) United States
(12) Patent Application Publication
(10) Pub. No.: US 2020/0327585 A1
(43) Pub. Date: Oct. 15, 2020

(54) SYSTEM FOR CORRELATING PUBLISHED REVIEWS TO A STORE FRONT GEOLOCATION

(71) Applicants: Bryan Boyce, Fruit Heights, UT (US); Brad T. Burton, Lehi, UT (US)

(72) Inventors: Bryan Boyce, Fruit Heights, UT (US); Brad T. Burton, Lehi, UT (US)

(21) Appl. No.: 16/382,163

(22) Filed: Apr. 11, 2019

(51) Int. Cl. G06Q 30/02; G06F 16/9536; G09F 9/302; G09F 9/35

(52) U.S. Cl. CPC G06Q 30/0282; G09F 9/35; G09F 9/302; G06F 16/9536

(57) ABSTRACT

A system and method for correlating published reviews and social media feedback to a geolocation is provided. The system displays a published review and/or social media feedback related to a business through signage that is prominently displayed at a business worksite. The signage comprises at least one display screen and a processor operatively connected to the display screen. The signage is configured to remain in communication with the Internet or a data storage unit, so as to retrieve the published review and social media feedback in real time. The business can program the processor in the signage to display the review and social media feedback at predetermined times. A review filter algorithm inhibits the business from manipulating the review and the social media feedback.

### FIELD OF THE INVENTION

This invention relates to system for correlating published reviews and social media feedback to a geolocation, and more particularly relates to a system that displays a summary of published reviews and/or social media feedback related to the business, directly at the worksite of the business through signage that remains in communication with the Internet or a data storage unit to retrieve the published review and/or social media feedback in real time, while also inhibiting manipulation of the published review and the social media feedback with a filter review algorithm.

### BACKGROUND DESCRIPTION OF THE RELATED ART

Typically, feedback from consumers is one of the most important aspects of any business. A business can collect such feedback and reviews through paper, phone, and online surveys, as well as online review web sites. Such reviews and surveys help a business learn how to improve to better meet the demands of the consumer so that those consumer can be retained. Similarly, the reviews and comments help provide a positive reputation for a business, which is important for attracting new consumers.

Generally, the Internet has thousands of sites where consumers rate businesses, rank businesses, comment on transactions and experiences they have had with businesses and more. Each of these interactions may be viewable by a business's potential consumers and clients. Positive and negative alike, every interaction is a fixture that the business may or may not be able to affect.

Despite the potential benefits, online reviews can be dangerous for the reputation of the business. The Internet is a haven of unfiltered content where reviewers often make anonymous comments that they would never say in person, and where reviewers make potentially libelous statements anonymously without regard to any consequences. For businesses which receive online customer service reviews, negative or false reviews can be harmful, as the reviews, even if untrue, are often prominently displayed and impossible to erase. Additionally, consumers are more likely to post negative reviews after a bad experience, than to post positive reviews after a good experience.

It is desirable, and an object of the present invention, to provide a business method and system that displays a published review and/or social media feedback related to the business, directly at the worksite of the business through signage that remains in communication with the Internet or a data storage unit to retrieve the published review and/or social media feedback in real time, while also inhibiting manipulation of the published review and the social media feedback with a filter review algorithm.

### SUMMARY

From the foregoing discussion, it should be apparent that a need exists for a business method and system for correlating published reviews and social media feedback to a business worksite. Beneficially, such a business method and system would display a published review and/or social media feedback related to the business, directly at the worksite of the business. The method and system provide a signage that is prominently displayed at the business worksite. The signage comprises at least one display and a processor. The signage is configured to remain in communication with the Internet or a data storage unit to retrieve the published review and/or social media feedback in real time. The present invention has been developed in response to the present state of the art, and in particular, in response to the problems and needs in the art that have not yet been fully solved by currently available published review web sites, and marketing efforts of storefronts. Accordingly, the present invention has been developed to provide a system for correlating published reviews and social media feedback to a business worksite, the system comprising: one more LCD screens adapted to be displayed in a storefront of a merchant geolocation, the LCD screens being operable at a storefront window of a worksite, the signage comprising at least one display screen and a processor operatively connected to the display screen, the signage being in operative communication via a WAN with a ratings provider; computer-readable memory bearing computer-readable instructions forming an API; an authorization module configured to receive via signal-bearing medium an authorization key from the ratings provider and to authenticate said authorization key; a reviewer module configured to receive a plurality of historical review files via a WAN, the historical review files stored in computer readable memory and displayed on one of the LCD screens; and a rating module adapted to receive rating information satisfying a filter review algorithm via the WAN from the ratings provider and to display the rating information on one of the LCD screens.

A second system for correlating published reviews and social media feedback to a business worksite is provided, the system comprising: a signage being operable at a storefront window of a worksite, the signage comprising at least one display screen and a processor operatively connected to the display screen, the signage being in operative communication with a WAN; the Internet and the data storage unit accessing a review or a social media feedback; the display screen displaying the review and the social media feedback at the worksite in response to the social media feedback and the signage satisfying a filter review algorithm.

The filter review algorithm may be satisfied when social media feedback is uploaded to computer readable storage by a consumer whose historical geolocated positions include the worksite.

The filter review algorithm may also be satisfied when GPS modules within the signage indicate the signage is geolocated at the worksite.

The signage may be configured to be in asynchronous communication with the Internet. The data storage unit may include at least one of the following: a subscriber identity module card, a universal serial bus, and a hard drive. The signage may comprise LED lighting. The at least one display screen may, in still further embodiments, comprise two oppositely facing screens, whereby the display screen is a dual-sided screen.

The at least one display screen may comprise at least one of the following: a cathode ray tube display, a light-emitting diode display, an electroluminescent display, an electronic paper, an e-Ink screen, a plasma display panel, a liquid crystal display, and an organic light-emitting diode display.

The system may further comprise, in alternative embodiments, an Internet modem and a router operatively connecting the processor with the Internet.

The system may further comprise a network interface controller operatively connecting the processor with the Internet.

The system may also further comprise an application programming interface (API) operatively connecting the signage with the Internet and the data storage unit.

The system may further comprise a global positioning system adapted to geolocate the signage on a GPS grid and relay the geolocation in GPS coordinates to ratings provider.

The review may comprise a published crowd-source review.

The social media feedback may include at least one of the following: a review, a comment, an approval, a disapproval, a social media feedback, an image, and a video.

A method for correlating published reviews and social media feedback to a business worksite is also provided, the method comprising: reviewing a business by creating a review comprising a numerical rating on a predetermined scale; uploading the review and geolocation where the business was reviewed using a web server, the web server being in operational communication via a WAN with storefront signage; uploading a geolocation of the storefront signage to the web server; converting an address of the business to a geolocation of the business; uploading the geolocation of the business to the web server; storing the review in computer-readable memory on a data storage unit; publishing the review on the storefront signage in response to the review satisfying a filter review algorithm which is satisfied when the geolocation of the business, the geolocation where the business was reviewed, and the geolocation of the storefront signage all match; wherein the storefront signage comprises: at least one display screen adapted to be mounted on a window and a processor operatively connected to the display screen, and GPS positioning system; operatively connecting the signage with the following: the Internet, the web server, and the data storage unit; displaying, through the display screen, a plurality of crowd-source reviews.

The method may further comprise a step of illuminating a lighting of the signage using LEDs and wherein an area of the at least one display screen is more than three square feet.

The geolocation of the business, the geolocation of a consumer, and the geolocation of the storefront may all be continuously uploaded to the webserver.

A consumer geolocated within close proximity of the business may be identified by name on the display in response to the geolocation of the business and the geolocation of the consumer being within a predetermined threshold.

The review may still further be publishing in response to an encrypted authorization key authenticating.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a data entity relationship diagram of an exemplary system for correlating published reviews and social media feedback to a business worksite and/or geolocation in accordance with the present invention;

FIG. 2A is a frontal view of a business store front displaying a review through a signage, in accordance with the present invention;

FIG. 2B is a frontal view of a business store front displaying a review through a signage, in accordance with the present invention;

FIG. 2C is a frontal view of a business store front displaying a review through a signage, in accordance with the present invention;

FIG. 3 illustrates a flowchart of an exemplary business method for correlating published reviews and social media feedback to a business worksite, in accordance with the present invention;

FIG. 4 is a block diagram depicting an exemplary client/server system which may be used by an exemplary web-enabled/networked embodiment of the present invention; and

FIG. 5 is a block diagram depicting a system for correlating published reviews with a store front location in accordance with one embodiment of the present invention.

### DETAILED DESCRIPTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

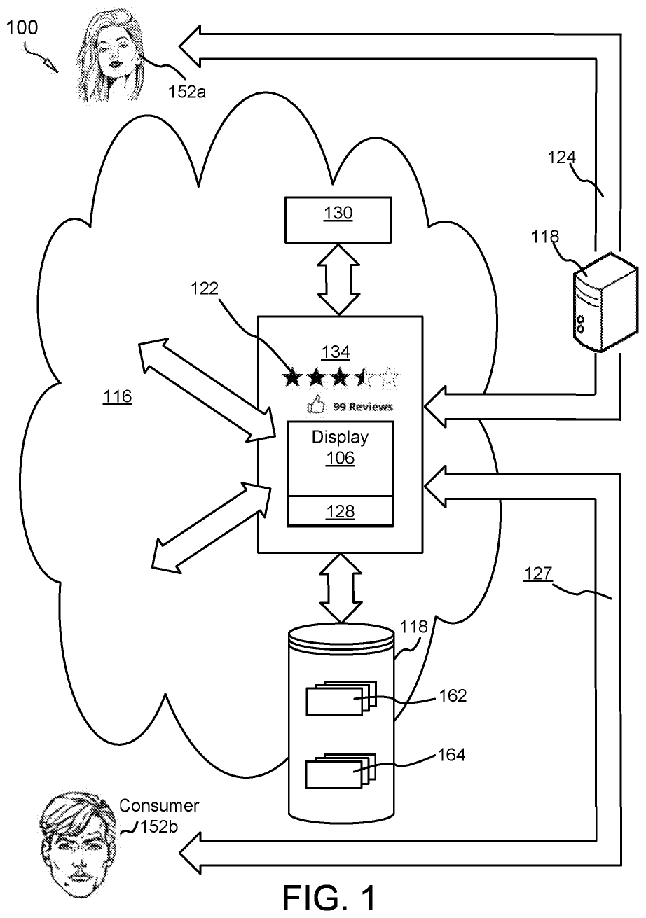

FIG. 1 depicts a data entity relationship diagram of an exemplary system 100 for correlating published reviews and social media feedback to a business worksite and/or geolocation. In one embodiment, the system 100 for correlating published reviews and social media feedback to a business worksite, hereafter “system 100” is configured to prominently display a published review 122 and/or a social media feedback 124 directly from a worksite 102 of a business 134. The displayed review 122 and social media feedback 124 helps relay to a consumer 152, the effectiveness of the business 134 in providing satisfactory products or services. Consequently, the prominent positioning of the signage 106 is evident to the consumer 152, such that the consumer 152 can view the reviews 122 and social media feedback 124 in real time, and at preprogrammed times, as selected by the business 134.

The system 100 is also unique in that a filter review algorithm 126 is integrally programmed into a signage processer, and through a web server 118 connected to the Internet 116. A filter review algorithm performs processes and manipulations of data to minimize manipulation of the published review 122 and the social media feedback 124. As a result, a verifiable, honest reviews 122 and social media feedback 124 displays in a prominent location of a worksite.

For instance, the geolocation locations 162 of consumers 152 may be stored in computer readable memory 118 and only review 127 from consumers shown to have actually visited the geolocation of the business 134 allowed a filter review algorithm to be displayed on the signage 106. In various other embodiments, signage 106 is deactivated if the signage itself is geolocated using internal GPS modules to be positioned somewhere outside the geographic confines of the physical business 134 location.

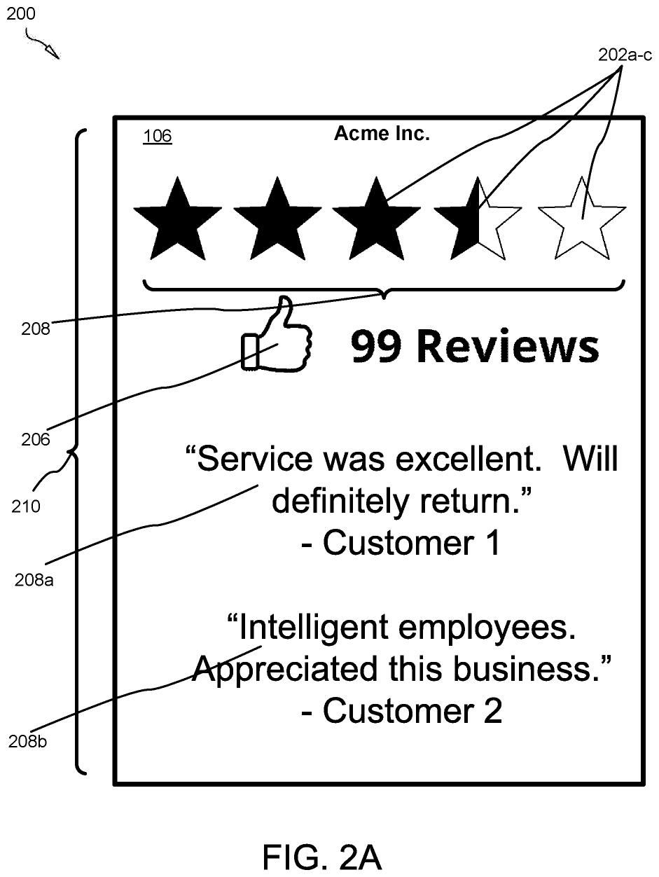

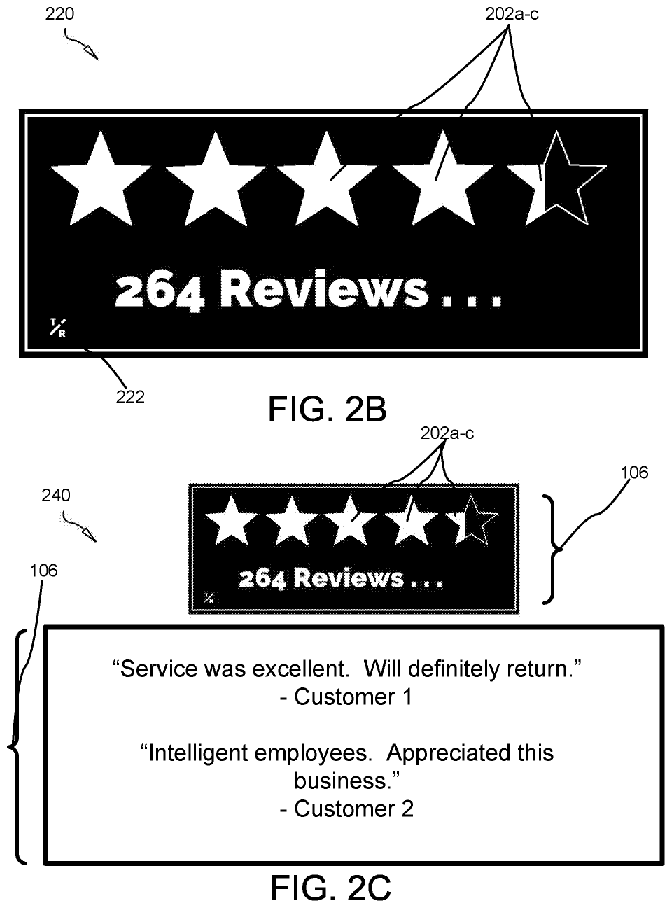

Turning now to FIG. 2, a sign 100 having a display 106 is illustrated in a prominent position at a business 134. In this illustration, the signage 104 is a large, illuminated marquee 200 that is prominently mounted over a store front of a business 134. Though in other embodiments, the signage 104 can also be designed as signs and symbols to communicate a message to a specific group, usually for the purpose of marketing or advocacy. A crowd-source review 210 prominently scrolls across a digital display 106 of the marquee/sign 200. In one exemplary review 208a, a consumer writes, “Service was excellent. Will definitely return.” A social media feedback 206 also displays a “like” symbol/image across the digital display 106. This can indicate that the previous consumer was satisfied with the product or service of Acme Inc. The symbol may indicate a composite score for a plurality of social media review.

Additionally, the marquee 106 displays a star rating system 208 that averages multiple reviews, and is some cases normalizes them, also displays across the digital display 106 of the marquee 200. This can includes a TrueRate™ rating that is known and trusted by consumers, which may be a composite of raking from a plurality of sources. As illustrated, Acme Inc. has earned 3 ½ stars. This star rating indicates an above average positive review from multiple consumers. However, it is significant to note that the system 100 can present myriad combinations of different displays 106 and review presentations within the frameworks of the present invention.

In some embodiments, the signage 104 may include a single sign, or multiple signs 200 arranged in a marketing-friendly configuration. The system 100 is scalable, such that the signage 104 can accommodate variously sized signs, different shapes, and different illumination and text configurations.

In another possible embodiment, the signage 200 comprises at least one display screen 106 and a processor operatively connected to the display screen 106. Further, text, videos, images, audio, and other forms of media may be displayed by the display screen 106.

The display screen 106 is configured to display the review 122 and the social media feedback 124 at the business 134. The review 122 may include a crows-source review for the business, such as found on review sites, i.e., Yelp™ or other review sites presently known or created in the future. The social media feedback 124 may include a “Like” on a social media site, such as Facebook™. The social media feedback 124 may also include, without limitation, a review, a comment, an approval, a disapproval, a social media feedback, an image, and a video. The social media site may include any social media site presently known or created in the future. The business 134 that is being reviewed and commented on may include a business having a product, a service, or an organization. The reviewers and social commenters may include a member of the public or another business.

In one possible embodiment, the at least one display screen 106 comprises two oppositely disposed screens, such as a dual-sided screen. This allows for viewing the reviews from multiple angles at the worksite 134. However in alternative embodiments, the display screen 106 may have three or more screens, such as a tele box screen.

In some embodiments, the display screen 106 may include, without limitation, a cathode ray tube display (CRT), a light-emitting diode display (LED), an electroluminescent display (ELD), an electronic paper, an e-Ink screen, a plasma display panel (PDP), a liquid crystal display (LCD), and an organic light-emitting diode display (OLED). In any case, the display screen 106 prominently displays text, images, videos, and any reference to the review 122 and the social media feedback 124.

In one embodiment, the signage 104 comprises a lighting 110 that is operable at or near the display screen 106. The lighting 110 is configured to enhance the view of the review 122 and social media feedback 124 while being displayed. The lighting 110 may include, without limitation, a light emitting diode, a liquid crystal display, a neon light, and a light bulb. The lighting 110 may be at the periphery of the signage 104, or may be integrated into the display screen 106.

Looking again at FIG. 1, the processor 108 that is operable in the signage 104 is used to communicate with the Internet 116, process the data contained in the data storage unit 120, and program times and dates to display the reviews 122 and social media feedback 124. In one non-limiting embodiment, the processor 108 comprises a low cost, credit-card sized computer that plugs into the display screen 106, such as Blueberry Pi™.

The processor 108 is in communication with the Internet 116 through various networking components known in the art. In one possible embodiment, a web server 118 in operative communication with the review 122 site or social media site publishes the review 122 and the social media review 122. The processor 108, through various networking components communicates, with the web server 118 to access the reviews 122 and social media feedback 124.

In another embodiment, the processor 108 comprises a network interface controller 128 (NIC) that operatively connects the processor 108 with the Internet 116. The NIC 128 includes a computer hardware component that connects the processor 108 to a computer network. Further, a network interface card can be used to provide the processor 108 with a dedicated, full-time connection to the Internet 116 or network.

In another embodiment, the processor 108 includes an application programming interface 130 (API) that operatively connects the signage 104 with the Internet 116 and the data storage unit 120. In another possible embodiment, an Internet modem 112 and a router 114 are integrated into the display screen 106. The modem 112 and router 114 for operatively connecting the signage 104 to the Internet 116. The modem 112 serves as a bridge between the local network and the Internet 116. The router 114 connects multiple networks and routes network traffic between them.

In one alternative embodiment, the system 100 provides a global positioning system 132 (GPS) to help in locating the signage 104 in relation to the worksite 102. The GPS 132 also helps consumers track the location of the worksite 102, based on the reviews 122 and social media feedback 124.

As discussed above, the Internet 116 enables the signage 104 to access the review 122 and the social media feedback 124. However, the system 100 is unique in that a data storage unit 120 may also be used by the signage 104 to access the reviews 122 and social media feedback 124. The data storage unit 120 operatively mates directly into the processor 108 through the display screen 106. The data storage unit 120 stores the data associated with the review 122 and social media feedback 124, including recorded text and videos. Thus, the reviews can be easily uploaded from the data storage unit 120 into the processor 108 for viewing on the display screen 106.

And while use of the data storage unit 120 may not allow for real time access, the review 122 and social media feedback 124 can still be relevantly up to date when stored in such a manner. In some embodiments, the data storage unit 120 may include, without limitation, a subscriber identity module (SIM) card, a universal serial bus (USB), and a hard drive.

Continuing, the system 100 also provides a filter review algorithm 126 that is programmable into the processor 108. The filter review algorithm 126 is operable to inhibit, or at least minimize, manipulation and fabrications of the published reviews 122 and the social media feedback 124. This helps ensure that the business 134 is not manipulating reviews to portray an enhanced product or service, i.e., fraud. This also ensures that competitors of the business 134 are not generating false negative reviews to damage the reputation of the business 134.

The server 118 may be under the control of a technology provider (or ratings provider) who provides ratings information derived from one or more historical reviews of customers.

Operation of the filter review algorithm 126 includes various processing manipulations known in the art of filtering software, probabilities, and Artificial Intelligence. In one embodiment, the filter review algorithm 126 is configured to count the number of reviews 122 received by the business 134. In another embodiment, the filter review algorithm 126 is configured to count the number of friends, associates, and reviewers associated with the business 134.

Continuing with the ways that the filter review algorithm 126 may operate to detect fraudulent reviews 122 and social media feedback 124, and prevent the business 134 from fabricating or changing the reviews 122, the filter review algorithm 126 also analyzes writing styles and grammar patterns of the reviews 122. This can indicate robo-reviewers or foreign-based reviewers that might be fraudulent. In another embodiment, the filter review algorithm 126 is configured to track the location of the reviewer and social media commenter. In another embodiment, the filter review algorithm 126 is configured to track the profile of the reviewer and social media commenter.

All of these review and social media feedback data points may then be processed to approximate the presence of false reviews. The filter review algorithm 126 may then alert the business, consumer, or reporting organization about the fraud. Or the filter review algorithm 126 may simply remove the reviews in question.

FIG. 2B is a frontal view of a business store front displaying a review through a signage 220, in accordance with the present invention.

A trademark 222 indicates on the display 220. In various embodiments, the system 100 comprises an upper and lower display. The upper display 220 is adapted to display only a rating 208 on a scale of one to five in some embodiments. In other embodiments, the display 220 also displays a number of reviews and the trademark 222 of the technology provider.

The signage 200 may comprise means for relaying and receiving electrical signals enabling device-to-device communication. The signage 200 may be configured to make use of the Bluetooth® protocols and procedures enabling device-to-device intercommunication connectivity. This functionality may be provided by incorporating the Bluetooth Intercom Profile® and/or the Bluetooth Telephony Profile®, or other wireless technologies known to those of skill in the art.

This communication may be in accordance with core specifications of one or more subsets of Bluetooth® profiles, wherein the core specifications comprise one or more of: the Cordless Telephony Profile (CTP), the Device ID Profile (DIP), the Dial-up Networking Profile (DUN), the File Transfer Profile (FTP), the Hands-Free Profile (HFP), the Human Interface Device Profile (HID), the Headset Profile (HSP), and the Intercom Profile (ICP), the Proximity Profile (PXP).

FIG. 2C is a frontal view of a business store front displaying a review through a signage 240, in accordance with the present invention.

In other embodiments, the system 100 comprises two display 220, 240, which may differ in size, area and dimensions. The upper display 220 may display comprise an digital LCD screen or may comprise an analog display adapted to light some, all or portions of five stars 202 shown

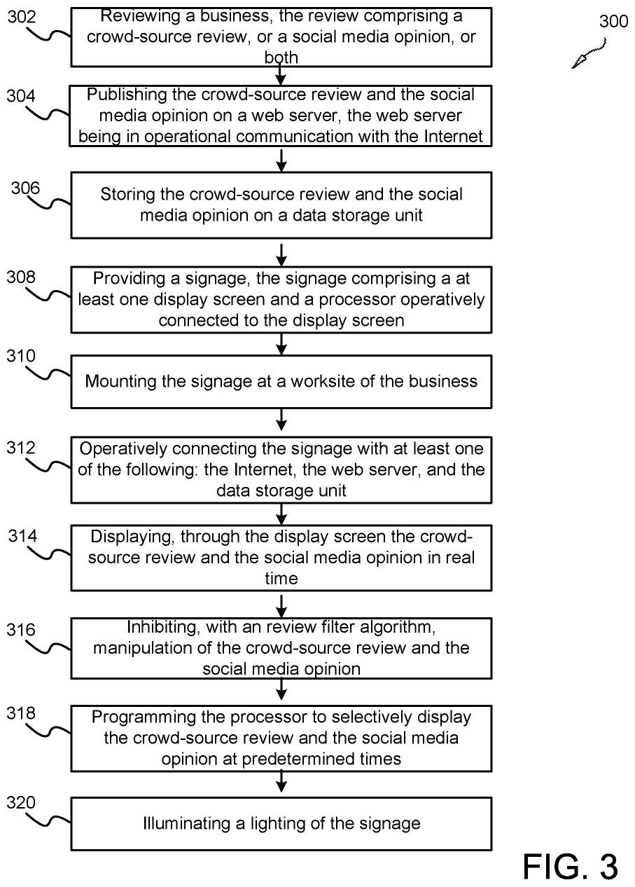

FIG. 3 illustrates a flowchart of an exemplary business method 300 for correlating published reviews and social media feedback to a business worksite. The method 300 in the disclosed embodiments substantially includes the steps necessary to carry out the functions presented above with respect to the operation of the described system. In one embodiment, the method 300 includes an initial Step 302 of reviewing a business, the review comprising a crowd-source review, or a social media feedback, or both. The reviewers and social commenters may include a member of the public or another business.

The method 300 may further comprise a Step 304 of publishing the crowd-source review and the social media feedback on a web server, the web server being in operational communication with the Internet. This can include the reviewers inputting the review directly onto the review site or social media site which is in operational communication with the web server. A Step 306 includes storing the crowd-source review and the social media feedback on a data storage unit. The data storage unit operatively mates directly into the processor through the display screen. The data storage unit stores the data associated with the review and social media feedback, including recorded text and videos.

In some embodiments, a Step 308 comprises providing a signage, the signage comprising at least one display screen and a processor operatively connected to the display screen. The signage may include a single sign, or multiple signs arranged in a marketing-friendly configuration. A Step 310 includes mounting the signage at a worksite of the business. In some embodiments, a Step 312 may include operatively connecting the signage with at least one of the following: the Internet, the web server, and the data storage unit.

A Step 314 comprises displaying, through the display screen the crowd-source review and the social media feedback in real time. The reviews indicate to the consumer the quality of product and service provided by the business. The method 300 may further comprise a Step 316 of inhibiting, with a review filter algorithm, manipulation of the crowd-source review and the social media feedback.

A Step 318 includes programming the processor to selectively display the crowd-source review and the social media feedback at predetermined times. The display screen may have a keyboard and mouse that are used to input commands for this purpose. A final Step 320 includes illuminating a lighting of the signage. The lighting is configured to enhance the view of the review and social media feedback while being displayed.

Although the process-flow diagrams show a specific order of executing the process steps, the order of executing the steps may be changed relative to the order shown in certain embodiments. Also, two or more blocks shown in succession may be executed concurrently or with partial concurrence in some embodiments. Certain steps may also be omitted from the process-flow diagrams for the sake of brevity. In some embodiments, some or all the process steps shown in the process-flow diagrams can be combined into a single process.

In various embodiments, a consumer reviews a business by creating a review on a mobile DPD (data processing device), the review comprising a numerical rating (stored as an int) on a predetermined scale, such as one to five stars. The review may be stored in computer-readable memory in an RDBMS and uploaded to the technology provider along with a geolocation where the business was reviewed by the consumer. The geolocation is determined using internal GPS systems within the mobile DPD of the consumer and the review is exclusively associated with the geolocation in the RDBMS. The web server is in operational communication via a WAN with storefront signage.

The storefront signage 200 likewise comprises internal GPS systems adapted to determine a real-time geolocation of the signage 200 and to upload the geolocation of the business to the web server; where the review, geolocation of the consumer and geolocation of the business are stored in computer-readable memory on a data storage unit.

The review is publishing on the storefront signage 200 in response to the review satisfying a filter review algorithm.

The filer review algorithm is satisfied when the geolocation of the business, the geolocation where the business was reviewed (the consumer geolocation), and the geolocation of the storefront signage all match in some embodiments. The coordinates of these geolocations are cross-referenced by the web server to determine if they match or fall within a predetermined match range, such as 100 feet in exemplary embodiments.

The method 300 may further comprise a step of illuminating a lighting of the signage using LEDs wherein an area of the at least one display screen is more than three square feet, four square feet, or more.

The geolocation of the business, the geolocation of a consumer, and the geolocation of the storefront may all be synchronously or asynchronously uploaded to the web server by the signage 200.

A consumer geolocated within close proximity of the business may be identified by name on the display in response to the geolocation of the business and the geolocation of the consumer being within a predetermined threshold.

The review may still further be publishing in response to an encrypted authorization key being authenticated. In various embodiments, this authorization key is relayed via the WAN to the signage 200 from the technology provided and authenticated by the signage 200. In still further embodiments, the authorization key is relayed from the signage 200 to the technology provider/web server and there authenticated.

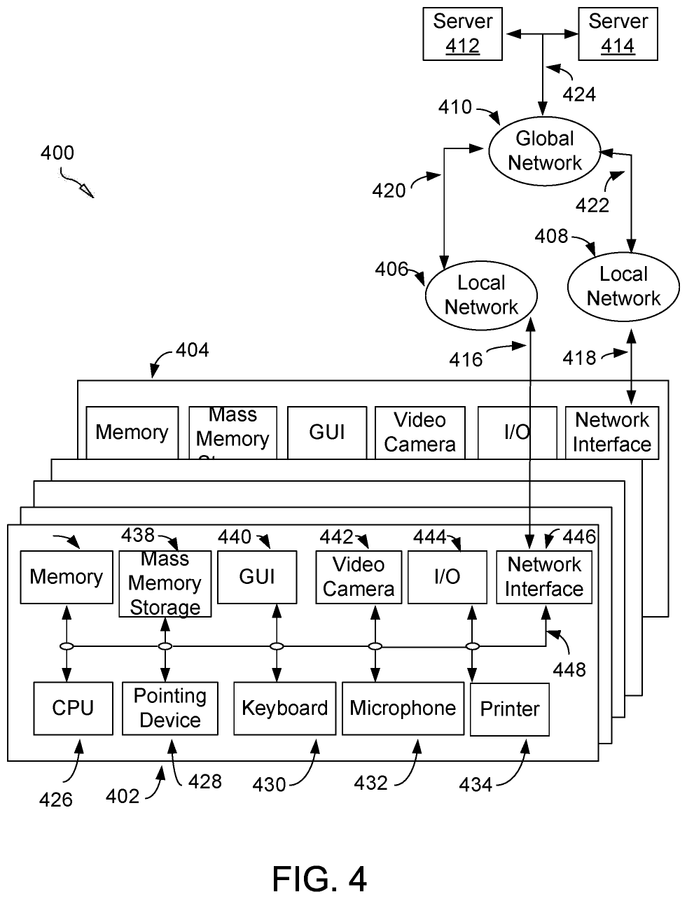

FIG. 4 is a block diagram depicting an exemplary client/server system which may be used by an exemplary web-enabled/networked embodiment of the present invention.

A communication system 400 includes a multiplicity of clients with a sampling of clients denoted as a client 402 and a client 404, a multiplicity of local networks with a sampling of networks denoted as a local network 406 and a local network 408, a global network 410 and a multiplicity of servers with a sampling of servers denoted as a server 412 and a server 414.

Client 402 may communicate bi-directionally with local network 406 via a communication channel 416. Client 404 may communicate bi-directionally with local network 408 via a communication channel 418. Local network 406 may communicate bi-directionally with global network 410 via a communication channel 420. Local network 408 may communicate bi-directionally with global network 410 via a communication channel 422. Global network 410 may communicate bi-directionally with server 412 and server 414 via a communication channel 424. Server 412 and server 414 may communicate bi-directionally with each other via communication channel 424. Furthermore, clients 402, 404, local networks 406, 408, global network 410 and servers 412, 414 may each communicate bi-directionally with each other.

In one embodiment, global network 410 may operate as the Internet. It will be understood by those skilled in the art that communication system 400 may take many different forms. Non-limiting examples of forms for communication system 400 include local area networks (LANs), wide area networks (WANs), wired telephone networks, wireless networks, or any other network supporting data communication between respective entities.

Clients 402 and 404 may take many different forms. Non-limiting examples of clients 402 and 404 include personal computers, personal digital assistants (PDAs), cellular phones and smartphones.

Client 402 includes a CPU 426, a pointing device 428, a keyboard 430, a microphone 432, a printer 434, a memory 436, a mass memory storage 438, a GUI 440, a video camera 442, an input/output interface 444 and a network interface 446.

CPU 426, pointing device 428, keyboard 430, microphone 432, printer 434, memory 436, mass memory storage 438, GUI 440, video camera 442, input/output interface 444 and network interface 446 may communicate in a unidirectional manner or a bi-directional manner with each other via a communication channel 448. Communication channel 448 may be configured as a single communication channel or a multiplicity of communication channels.

CPU 426 may be comprised of a single processor or multiple processors. CPU 426 may be of various types including micro-controllers (e.g., with embedded RAM/ROM) and microprocessors such as programmable devices (e.g., RISC or SISC based, or CPLDs and FPGAs) and devices not capable of being programmed such as gate array ASICs (Application Specific Integrated Circuits) or general purpose microprocessors.

As is well known in the art, memory 436 is used typically to transfer data and instructions to CPU 426 in a bi-directional manner. Memory 436, as discussed previously, may include any suitable computer-readable media, intended for data storage, such as those described above excluding any wired or wireless transmissions unless specifically noted. Mass memory storage 438 may also be coupled bi-directionally to CPU 426 and provides additional data storage capacity and may include any of the computer-readable media described above. Mass memory storage 438 may be used to store programs, data and the like and is typically a secondary storage medium such as a hard disk. It will be appreciated that the information retained within mass memory storage 438, may, in appropriate cases, be incorporated in standard fashion as part of memory 436 as virtual memory.

CPU 426 may be coupled to GUI 440. GUI 440 enables a user to view the operation of computer operating system and software. CPU 426 may be coupled to pointing device 428. Non-limiting examples of pointing device 428 include computer mouse, trackball and touchpad. Pointing device 428 enables a user with the capability to maneuver a computer cursor about the viewing area of GUI 440 and select areas or features in the viewing area of GUI 440. CPU 426 may be coupled to keyboard 430. Keyboard 430 enables a user with the capability to input alphanumeric textual information to CPU 426. CPU 426 may be coupled to microphone 432. Microphone 432 enables audio produced by a user to be recorded, processed and communicated by CPU 426. CPU 426 may be connected to printer 434. Printer 434 enables a user with the capability to print information to a sheet of paper. CPU 426 may be connected to video camera 442. Video camera 442 enables video produced or captured by user to be recorded, processed and communicated by CPU 426.

CPU 426 may also be coupled to input/output interface 444 that connects to one or more input/output devices such as such as CD-ROM, video monitors, track balls, mice, keyboards, microphones, touch-sensitive displays, transducer card readers, magnetic or paper tape readers, tablets, styluses, voice or handwriting recognizers, or other well-known input devices such as, of course, other computers.

Finally, CPU 426 optionally may be coupled to network interface 446 which enables communication with an external device such as a database or a computer or telecommunications or internet network using an external connection shown generally as communication channel 416, which may be implemented as a hardwired or wireless communications link using suitable conventional technologies. With such a connection, CPU 426 might receive information from the network, or might output information to a network in the course of performing the method steps described in the teachings of the present invention.

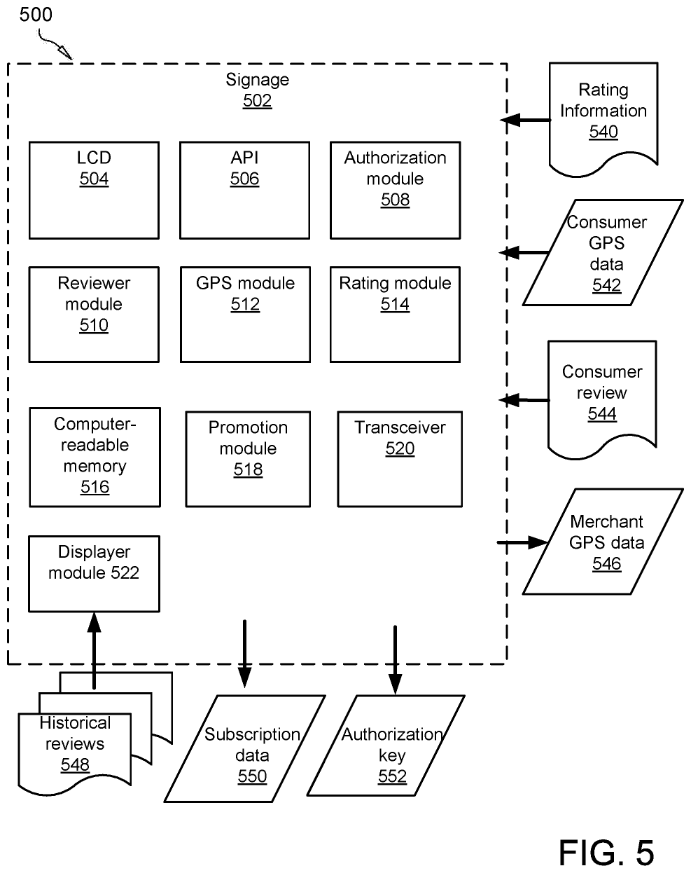

FIG. 5 is a block diagram depicting a system 500 for correlating published reviews with a store front location in accordance with one embodiment of the present invention.

The system 500 comprises a display 504, in the shown embodiment an LCD display; along with computer-readable memory 516 comprising computer-readable instructions forming an API 506. An authorization module 508 receives an authorization key 552 from a server 118 under the control of a technology provider. The authorization key 552 may be encrypted using means known to those of skill in the art. In various embodiments, the authorization key 552 in unencrypted form comprises a Boolean indicating a positive or negative value. In various embodiments, the display 504 and the rating module 514 and the reviewer module 510 are all activated in response to the authorization module 508 receiving an authorization key 552 which authenticates, or indicates positive upon decryption, such that the technology provider controlling the relaying server 118 controls the signage 500—the ability of the signage 500 to function in accordance with the present invention.

Once the signage 500 is configured to function by the authorization module 408, a reviewer module 510 receives historical consumer reviews 548 into computer-readable memory 516 in a RDBMS (relational database management system). These reviews are displayed on signage 200. In some cases, the reviews 548 are received asynchronously and in other embodiments they are received synchronously.

Data, including data 540-552, is received by the system 500 using a transceiver 520. A rating module 514 receives an integer or long indicating a rating for a business located at the geolocation of the signage 200. In various embodiments, this long may by way of example: 4.45, which would indicate a rating of 4.45 stars on a scale of 0 to 5 stars. Other rating systems may be used, including percentile rating systems.

The rating 208 for a merchant 134 is calculated by the technology provided and/or the server 118 using a rating algorithm, which compiles ratings from historical consumers who have chosen to publish reviews of the business, or even ratings from consumers 152 whose ratings are inferred from nonpublication but who are know from historical GPS data to have visited the merchant 134. In various embodiments, consumer 152 geolocation data is stored in computer-readable RDBMS memory by the server 118.

A unique identifier may be associated in computer-readable memory with each merchant 134 enrolled with the technology provided, and that unique identifier than associated in historical GPS with locations at which consumers 152 have stopped for more than a predetermined amount of time, such as five minutes.

The promotion module 518 may be configured to push notifications to a consumer within a predetermined distance from the signage 200. The displayer module 522 may be disabled in response to the authorization key failing to authenticate or failing to decrypt.

The API may be adapted to asynchronously update the geolocation of the signage 200 with the technology provider.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A system for correlating published reviews and social media feedback to a business worksite, the system comprising:
one more LCD screens adapted to be displayed in a storefront of a merchant geolocation, the LCD screens being operable at a storefront window of a worksite, the signage comprising at least one display screen and a processor operatively connected to the display screen, the signage being in operative communication via a WAN with a ratings provider;
computer-readable memory bearing computer-readable instructions forming an API;
an authorization module configured to receive via signal-bearing medium an authorization key from the ratings provider and to authenticate said authorization key;
a reviewer module configured to receive a plurality of historical review files via a WAN, the historical review files stored in computer readable memory and displayed on one of the LCD screens; and
a rating module adapted to receive rating information satisfying a filter review algorithm via the WAN from the ratings provider and to display the rating information on one of the LCD screens.

2. A system for correlating published reviews and social media feedback to a business worksite, the system comprising:
a signage being operable at a storefront window of a worksite, the signage comprising at least one display screen and a processor operatively connected to the display screen, the signage being in operative communication with a WAN;
the Internet and the data storage unit accessing a review or a social media feedback;
the display screen displaying the review and the social media feedback at the worksite in response to the social media feedback and the signage satisfying a filter review algorithm.

3. The system of claim 1, wherein the filter review algorithm is satisfied when social media feedback is uploaded to computer readable storage by a consumer whose historical geolocated positions include the worksite.

4. The system of claim 1, wherein the filter review algorithm is satisfied when GPS modules within the signage indicate the signage is geolocated at the worksite.

5. The system of claim 1, wherein the signage is configured to be in asynchronous communication with the Internet.

6. The system of claim 1, wherein the data storage unit includes at least one of the following: a subscriber identity module card, a universal serial bus, and a hard drive.

7. The system of claim 1, wherein the signage comprises lighting.

8. The system of claim 1, wherein the at least one display screen comprises two oppositely facing screens, whereby the display screen is a dual-sided screen.

9. The system of claim 8, wherein the at least one display screen comprises at least one of the following: a cathode ray tube display, a light-emitting diode display, an electroluminescent display, an electronic paper, an e-Ink screen, a plasma display panel, a liquid crystal display, and an organic light-emitting diode display.

10. The system of claim 1, further comprising an Internet modem and a router operatively connecting the processor with the Internet.

11. The system of claim 1, further comprising a network interface controller operatively connecting the processor with the Internet.

12. The system of claim 1, further comprising an application programming interface (API) operatively connecting the signage with the Internet and the data storage unit.

13. The system of claim 1, further comprising a global positioning system adapted to geolocate the signage on a GPS grid and relay the geolocation in GPS coordinates to ratings provider.

14. The system of claim 1, wherein the review comprises a published crowd-source review.

15. The system of claim 1, wherein the social media feedback includes at least one of the following: a review, a comment, an approval, a disapproval, a social media feedback, an image, and a video.

16. A method for correlating published reviews and social media feedback to a business worksite, the method comprising:
reviewing a business by creating a review comprising a numerical rating on a predetermined scale;
uploading the review and geolocation where the business was reviewed using a web server, the web server being in operational communication via a WAN with storefront signage;
uploading a geolocation of the storefront signage to the web server;
converting an address of the business to a geolocation of the business;
uploading the geolocation of the business to the web server;
storing the review in computer-readable memory on a data storage unit;
publishing the review on the storefront signage in response to the review satisfying a filter review algorithm which is satisfied when the geolocation of the business, the geolocation where the business was reviewed, and the geolocation of the storefront signage all match;
wherein the storefront signage comprises: at least one display screen adapted to be mounted on a window and a processor operatively connected to the display screen, and GPS positioning system;
operatively connecting the signage with the following: the Internet, the web server, and the data storage unit;
displaying, through the display screen, a plurality of crowd-source reviews.

17. The method of claim 16, further comprising a step of illuminating a lighting of the signage using LEDs and wherein an area of the at least one display screen is more than three square feet.

18. The method of claim 16, wherein the geolocation of the business, the geolocation of a consumer, and the geolocation of the storefront are all continuously uploaded to the webserver.

19. The method of claim 16, wherein a consumer geolocated within close proximity of the business is identified by name on the display in response to the geolocation of the business and the geolocation of the consumer being within a predetermined threshold.

20. The method of claim 16, wherein the review is publishing in response to an encrypted authorization key authenticating.
